(19) United States
(12) Patent Application Publication
(10) Pub. No.: US 2017/0223783 A1
(43) Pub. Date: Aug. 3, 2017

(54) HEATING PROCESS MANAGEMENT WITH FURNACE VOLUME ESTIMATION

(71) Applicant: SABIC GLOBAL TECHNOLOGIES B.V., Bergen op Zoom (NL)

(72) Inventor: Othman N. ALZEGHAIBI, Riyadh (SA)

(21) Appl. No.: 15/501,035

(22) PCT Filed: Aug. 26, 2015
(86) PCT No.: PCT/IB2015/001994

§ 371 Date: Feb. 1, 2017

Related U.S. Application Data
(60) Provisional application No. 62/043,518, filed on Aug. 29, 2014.

(51) Int. Cl. H05B 7/148; F27D 19/00; H05B 7/20; G05D 23/19; C21C 5/52

(52) U.S. Cl. CPC H05B 7/148; G05D 23/1917; C21C 5/52; C21C 5/527; H05B 7/20; F27D 19/00; F27D 2019/0037; F27D 2019/0075; F27D 2019/0003; F27D 21/0035

(57) ABSTRACT

Methods and systems for managing a heating process are disclosed. An example method can comprise removing a first portion of a material from a vessel and measuring a first parameter of a second portion of the material in the vessel. The second portion of the material can remain in the vessel after the removal of the first portion. The method can comprise, determining a volume of the second portion of the material based on the first parameter, updating a second parameter based on the volume, and performing a process based on the updated second parameter.

### SUMMARY

It is to be understood that both the following general description and the following detailed description are exemplary and explanatory only and are not restrictive, as claimed. Provided are methods and systems for managing a heating process. An example method can comprise removing a first portion of a material from a vessel and measuring a first parameter of a second portion of the material in the vessel. The second portion of the material can remain in the vessel after the removal of the first portion. The method can comprise determining a volume of the second portion of the material based on the first parameter, updating a second parameter based on the volume, and performing a process based on the updated second parameter.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram illustrating an exemplary system for managing a process;

FIG. 2 is a diagram illustrating an exemplary furnace for heating a material;

FIG. 3 is a flowchart illustrating an example method for managing a heating process; and

FIG. 4 is a block diagram illustrating an example computing device in which the present methods and systems can be implemented.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present disclosure relates to methods and systems for managing a heating process. The present methods and systems are used to manage the heating process by estimating the material remaining in a vessel, such as a steel making vessel. A hearth of a steel making vessel (e.g., the electric arc furnace) can be in the shape of a partial sphere. The present methods and systems estimate the remaining portion of the liquid steel (e.g., the hot heel) in a vessel by estimating the volume and multiplying the volume by density. The volume of remaining portion of the steel in the hearth is calculated on the assumption that the portion of the vessel containing the remaining portion of the steel is in the shape of a partial sphere in which the sphere radius of the vessel is a known quantity for each vessel and the reminder height is measurable. More accurate estimation of the hot heel can energy consumption and unnecessary processing.

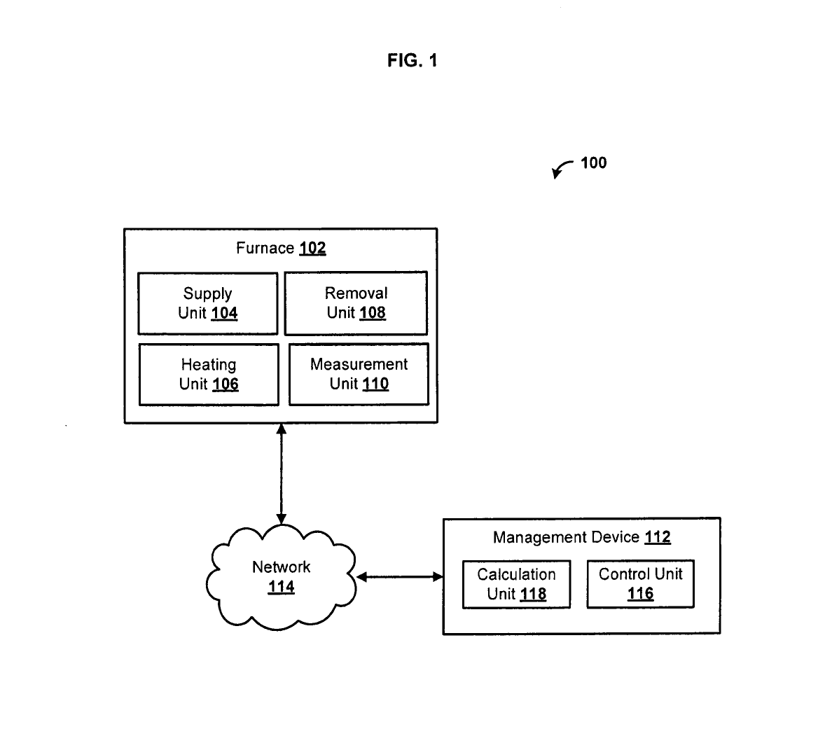

FIG. 1 is a block diagram illustrating an exemplary system 100 for managing a process. Those skilled in the art will appreciate that present methods may be used in systems that employ both digital and analog equipment. One skilled in the art will appreciate that provided herein is a functional description and that the respective functions can be performed by software, hardware, or a combination of software and hardware.

In one aspect, the system 100 can comprise a furnace 102. The furnace 102 can be configured to heat materials. For example, the furnace 102 can comprise a vessel to contain materials, heating elements (e.g., electrodes) to heat the materials in the vessel, pouring components configured to control addition and/or removal of materials from the vessel.

In one aspect, the furnace 102 can comprise a supply unit 104 configured to supply materials to the furnace 102. The supply unit 104 can be configured to receive a supply instruction indicating an amount of one or more materials (e.g., metals, additives) to supply to the vessel. The supply unit 104 can supply the one or more materials according to the supply instruction.

In another aspect, the furnace 102 can comprise a heating unit 106 configured to heat materials in the furnace 102. For example, the heating unit 106 can comprise one or more heating element, such as electrodes. The heating element can directly heat the material, heat the material by passing an electrical current through the material between the electrodes, and/or apply heat using other techniques. The heating unit 106 can be configured to receive an instruction indicating heating information, such as an amount of energy to apply to the material, an amount of heat to apply to the material, a temperature to bring (e.g., raise, lower) the material to, a duration of time to apply the heat and/or energy to the material, and/or the like. The heating unit 106 can be configured to operate the heating element based on the heating instruction.

In one aspect, the furnace 102 can comprise a removal unit 108 configured to remove materials from the vessel. For example, the removal unit 108 can comprise one or more valves, trap doors, a tilting mechanism configured to tilt the vessel, and/or the like. The removal unit 108 can be configured to receive a removal instruction indicating when (e.g., and for how long) to perform a removal operation (e.g., tilt the vessel, open a valve or trap door, pump the material out of the vessel). The removal unit 108 can be configured to perform the removal operation according to the removal instruction.

In one aspect, the furnace 102 can comprise a measurement unit 108 configured to measure one or more parameters related to the furnace 102. For example, the measurement unit 108 can comprise one or more sensors configured to measure temperature, weight, height of the material in the vessel and/or the like. The measurement unit 108 can be configured to provide the measured parameters to a device (e.g., management device 110).

The furnace 102 can be operated and/or controlled manually or by a computing device. For example, the components of the furnace 102 can be operated and controlled manually (e.g., by valves, levers, switches, and/or the like), by a local computer, by a remote computer, and/or the like. For example, the supply unit 104, heating unit 106, removal unit 108, measurement unit 110, and/or the like can be configured to receive and/or transmit information (e.g., instructions, sensor data) to a local and/or remote computer.

In one aspect, the system 100 can comprise a management device 112 configured to manage the furnace 102. It should be noted that, while only one management device 112 is shown, it is contemplated that additional management devices can be used in various implementations. The management device 112 can be communicatively coupled to the furnace 102 through a bus and/or network 114. In one aspect, the network 114 can comprise a packet switched network (e.g., internet protocol based network), a non-packet switched network (e.g., modulation based network), and/or the like. The network 114 can comprise network adapters, switches, routers, modems, and the like connected through wireless links (e.g., radio frequency, satellite) and/or physical links (e.g., fiber optic cable, coaxial cable, Ethernet cable, or a combination thereof). In one aspect, the network 114 can be configured to provide communication from telephone, cellular, modem, and/or other electronic devices to and throughout the system 100.

In one aspect, the management device 112 can comprise a control unit 116. The control unit 116 can be configured to control the furnace 102. For example, the control unit 116 can be configured to receive sensor data from the furnace 102. The control unit 116 can store the sensor data, provide the sensor data to a user, and/or otherwise process the sensor data. For example, the control unit 116 can provide a notification, such as warning based on a comparison of the sensor data to a threshold. In another aspect, the control unit 116 can be configured to generate a signal, message, instruction, and/or the like configured to control operation of the furnace 102. For example, the control unit 118 can provide an instruction to the furnace 102 or to a device associated therewith (e.g., terminal) to modify, update, adjust, and/or otherwise change a state of the furnace 102. The instruction can be automatically implemented by the furnace 102 or manually by a technician. As an illustration, the instruction can be indicative of turning a valve (e.g., on or off), modifying a state of a switch or lever, altering a supply of a material, changing a temperature, changing a pressure, and/or the like. As a further example, the instruction can be configured to initiate, alter, and/or stop a heating operation, supply operation (e.g. pouring, injecting, or otherwise adding), purification operation, draining operation, engaging or disengaging a mechanical element, and/or the like.

In one aspect, the management device 112 can comprise a calculation unit 118 configured to calculate, estimate, and/or otherwise determine one or more parameters relevant to the furnace 102. For example, the calculation unit 118 can be configured to calculate a mass of a first portion of material that remains after a second portion of the material is removed from the furnace 102. The mass can be provided to the control unit 116 to determine an operation parameter. The control unit 116 can provide an instruction to control an operation of the furnace based on the operation parameter. For example, the control unit 116 can determine an optimal time duration to apply a heating operation, an optimal amount of material to supply, an optimal amount of energy to provide for heating the material, and/or the like. The optimal amount and/or time can allow the furnace to operate while minimizing amounts of energy, time, and/or material wasted by a heating process.

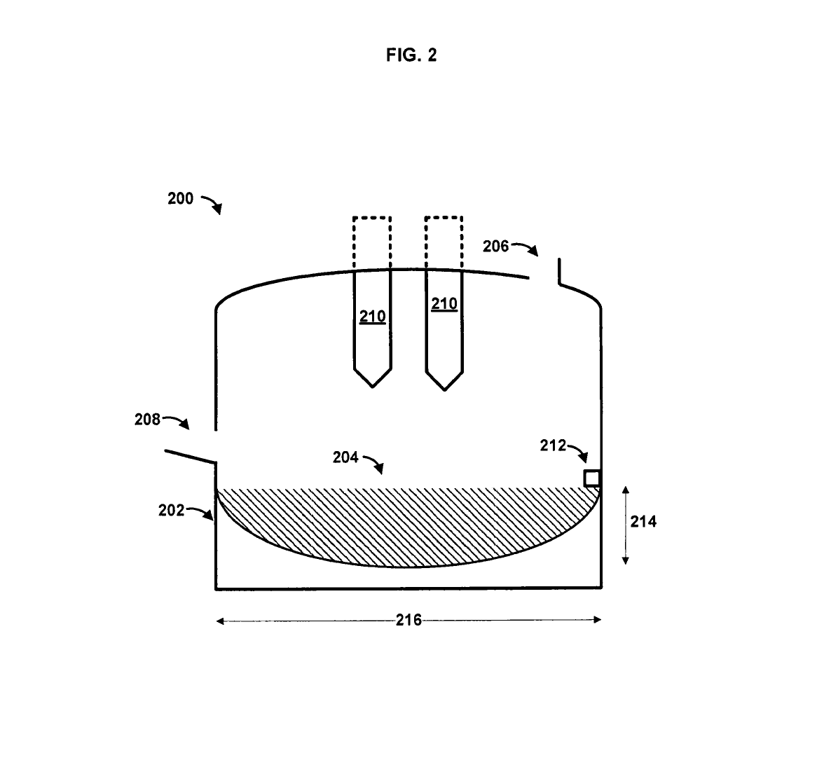

In one aspect, a mass of a portion of material can be determined based on a calculated volume. For example, the calculation unit 118 can be configured to calculate a volume based one or more parameters determined by the measurement unit 110, such as a height of material in the vessel. The volume can be calculated based on the shape of the vessel. For example, the volume can be calculated based on a partial sphere formula. For example, the first portion of the material remaining in the vessel can comprise a hot heel (e.g., remaining portion after material is removed from vessel). The volume of the hot heel can be determined based on following formula: Hot Heel Volume=(π/3)×Hot Heel height²×(1.5×vessel diameter−Hot Heel height). More generally, the volume can be determined as follows: Volume of Material=(π/3)×material height²×(1.5×vessel diameter−material height). For example, the vessel diameter can comprise the width 216 illustrated in FIG. 2. The material height can comprise the height 214 illustrated in FIG. 2.

FIG. 2 is a diagram illustrating an exemplary furnace 200 for heating a material. For example, the furnace 200 can comprise an electric arc furnace. In one aspect, the furnace 200 can comprise a vessel 202. The vessel 202 can be configured to contain a material 204 (e.g., during a heating process). The furnace 200 can comprise an inlet 206 for supplying material 204 (e.g., metals, additives) to the vessel 202. The furnace 200 can comprise an outlet 208 for removing (e.g., pouring, draining) melted material 204. In one aspect, the furnace 200 can comprise one or more heating elements 210. The heating elements 210 can be configured to transfer heat, energy, and/or the like to the material. For example, the heating elements 210 can comprise electrodes configured to pass a current through the material between the electrodes.

In one aspect, the furnace 202 can comprise one or more sensors 212. The one or more sensors 212 can be located at variety of places inside and/or outside of the vessel 202. For example, the one or more sensors 212 can be attached to a surface of the vessel, to an electrode, in the inlet 206 and/or outlet 208, and/or the like. The one or more sensors 212 can be configured to determine one or more first parameters, such as a height 214 of the material in the vessel, a width 216 of the material in the vessel, a size of the material in the vessel, a shape of the material in the vessel, and/or the like. For example, the one or more sensors 212 can be configured to measure the first parameter after the second portion of the material is removed from the vessel. For example, the first parameter can be based on a measurement of the first portion (e.g., the portion remaining in the vessel) of the material.

In one aspect, the one or more sensors 212 can be configured to provide the one or more first parameters to a remote device (e.g., management device 112 of FIG. 1). The remote device can be configured to determine one or more second parameters based on the one or more first parameters. The second parameters can comprise a parameter for controlling operation of the furnace 212. For example, the second parameter can comprise an amount of additional material to supply into the vessel, an amount of energy to apply to the material in the vessel, a temperature to apply to material in the vessel, an amount of additives to supply into the vessel, an amount of time to run a heating process upon the material in the vessel, and/or the like.

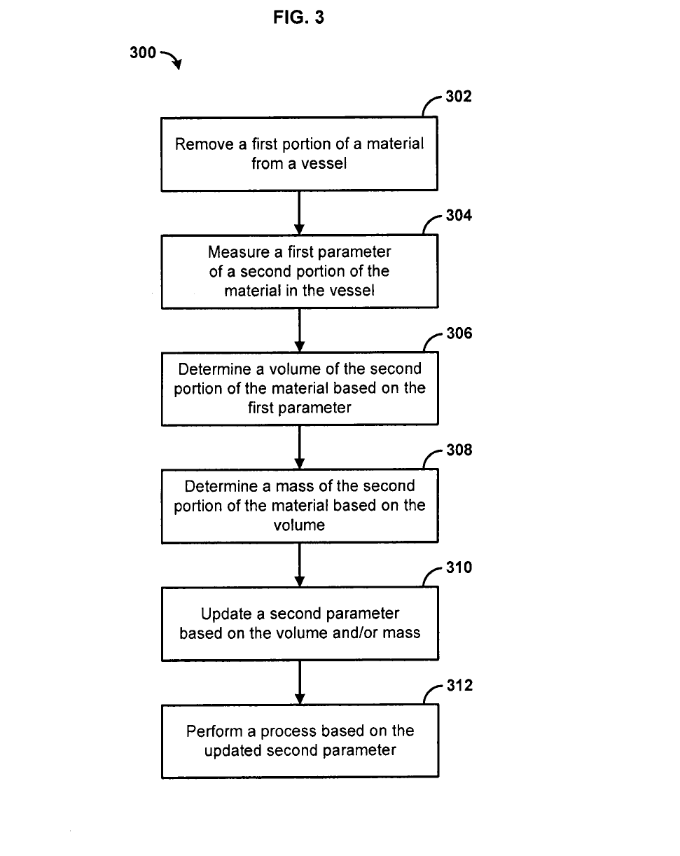

FIG. 3 is a flowchart illustrating an example method 300 for managing a heating process. At step 302, a first portion of a material can be removed from the vessel. For example, the vessel can comprise a part of a furnace, such as an electric arc furnace. In one aspect, the material can comprise molten material, such as a metal (e.g., steel). The material can be removed by pouring the material out of the vessel, draining the material through a trap door, and/or the like.

At step 304, a first parameter of a second portion of the material in the vessel can be measured. The second portion of the material can remain in the vessel after the removal of the first portion. The first parameter can comprise at least one of a height of the second portion of the material, a size of the second portion of the material, a shape of the second portion of the material, and/or the like.

At step 306, a volume of the second portion of the material can be determined based on the first parameter. The volume of the second portion of the material can be determined based on an assumption that the volume is shaped as a partial sphere, rectangle, ellipsoid, or other shape. At step 308, a mass of the second portion of the material can be determined based on the volume. For example, a density formula can be used to determine the mass (e.g., density=mass×volume).

At step 310, a second parameter can be updated based on the volume, mass, and/or the like. For example, the second parameter can be updated based on the mass of the second portion of the material. The second parameter can comprise at least one of an amount of additional material to provide to the vessel, an amount of energy to provide in the vessel, a temperature to bring the material to in the vessel, an amount of additives to provide to the vessel, an amount of time to perform a heating process in the vessel, and/or the like.

At step 312, a process can be performed (e.g., or continued to be performed) based on the updated second parameter. Performing the process can comprise providing additional material to the vessel. The amount of the additional material can be determined based on the second parameter. In an aspect, the process can comprise a metal making process. For example, the metal making process can comprise a steel making process. For example, the second portion of the material can comprise a steel hot heel and the vessel can comprise a steel making vessel. Performing the process can also comprise providing the energy to the vessel, bringing the material in the vessel to the temperature, providing the additives to the vessel, performing a heating process, and/or the like.

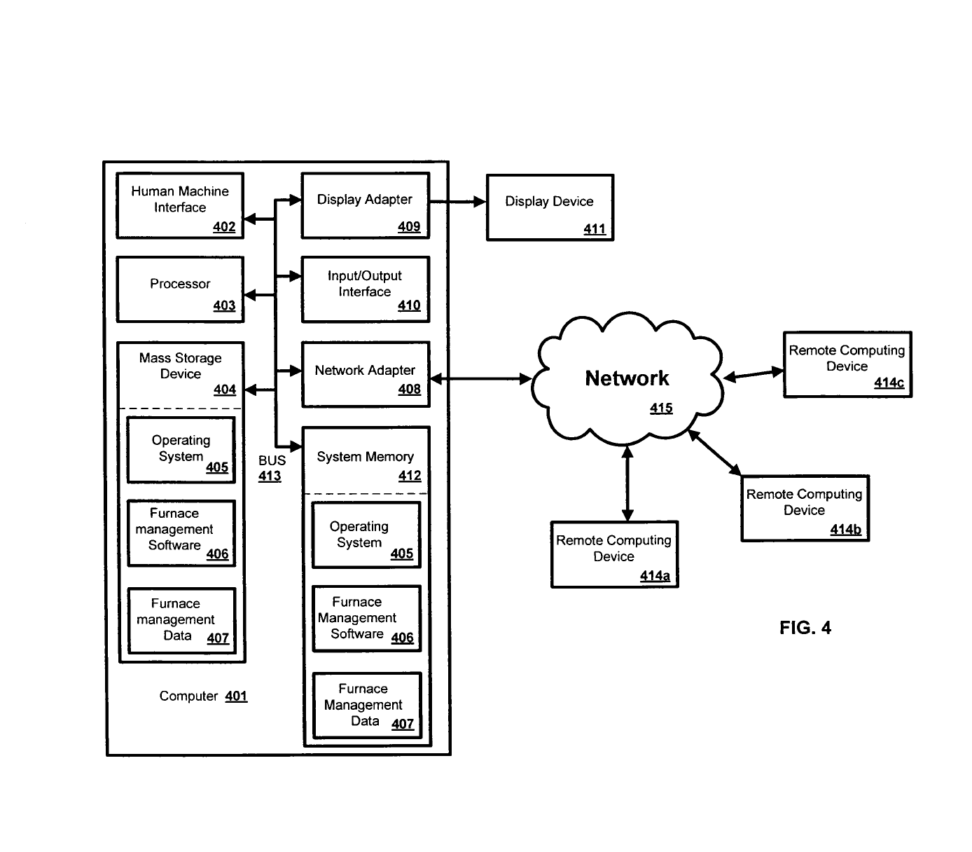

In an exemplary aspect, the methods and systems can be implemented on a computer 401 as illustrated in FIG. 4 and described below. By way of example, the furnace 102 and/or management device 112 of FIG. 1 can be and/or comprise a computer as illustrated in FIG. 4. Similarly, the methods and systems disclosed can utilize one or more computers to perform one or more functions in one or more locations. FIG. 4 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 401. The components of the computer 401 can comprise, but are not limited to, one or more processors or processing units 403, a system memory 412, and a system bus 413 that couples various system components including the processor 403 to the system memory 412. In the case of multiple processing units 403, the system can utilize parallel computing.

The system bus 413 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 413, and all buses specified in this description can also be implemented over a wired or wireless network connection and each of the subsystems, including the processor 403, a mass storage device 404, an operating system 405, furnace management software 406, furnace management data 407, a network adapter 408, system memory 412, an Input/Output Interface 410, a display adapter 409, a display device 411, and a human machine interface 402, can be contained within one or more remote computing devices 414a,b,c at physically separate locations, connected through buses of this form, in effect implementing a fully distributed system.

The computer 401 typically comprises a variety of computer readable media. Exemplary readable media can be any available media that is accessible by the computer 401 and comprises, for example and not meant to be limiting, both volatile and non-volatile media, removable and non-removable media. The system memory 412 comprises computer readable media in the form of volatile memory, such as random access memory (RAM), and/or non-volatile memory, such as read only memory (ROM). The system memory 412 typically contains data such as furnace management data 407 and/or program modules such as operating system 405 and furnace management software 406 that are immediately accessible to and/or are presently operated on by the processing unit 403.

In another aspect, the computer 401 can also comprise other removable/non-removable, volatile/non-volatile computer storage media. By way of example, FIG. 4 illustrates a mass storage device 404 which can provide non-volatile storage of computer code, computer readable instructions, data structures, program modules, and other data for the computer 401. For example and not meant to be limiting, a mass storage device 404 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 404, including by way of example, an operating system 405 and furnace management software 406. Each of the operating system 405 and furnace management software 406 (or some combination thereof) can comprise elements of the programming and the furnace management software 406. Furnace management data 407 can also be stored on the mass storage device 404. Furnace management data 407 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 401 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 403 via a human machine interface 402 that is coupled to the system bus 413, but can be connected by other interface and bus structures, such as a parallel port, game port, an IEEE 1394 Port (also known as a Firewire port), a serial port, or a universal serial bus (USB).

In yet another aspect, a display device 411 can also be connected to the system bus 413 via an interface, such as a display adapter 409. It is contemplated that the computer 401 can have more than one display adapter 409 and the computer 401 can have more than one display device 411. For example, a display device can be a monitor, an LCD (Liquid Crystal Display), or a projector. In addition to the display device 411, other output peripheral devices can comprise components such as speakers (not shown) and a printer (not shown) which can be connected to the computer 401 via Input/Output Interface 410. Any step and/or result of the methods can be output in any form to an output device. Such output can be any form of visual representation, including, but not limited to, textual, graphical, animation, audio, tactile, and the like. The display 411 and computer 401 can be part of one device, or separate devices.

The computer 401 can operate in a networked environment using logical connections to one or more remote computing devices 414a,b,c. By way of example, a remote computing device can be a personal computer, portable computer, smartphone, a server, a router, a network computer, a peer device or other common network node, and so on. Logical connections between the computer 401 and a remote computing device 414a,b,c can be made via a network 415, such as a local area network (LAN) and/or a general wide area network (WAN). Such network connections can be through a network adapter 408. A network adapter 408 can be implemented in both wired and wireless environments. Such networking environments are conventional and commonplace in dwellings, offices, enterprise-wide computer networks, intranets, and the Internet.

For purposes of illustration, application programs and other executable program components such as the operating system 405 are illustrated herein as discrete blocks, although it is recognized that such programs and components reside at various times in different storage components of the computing device 401, and are executed by the data processor(s) of the computer. An implementation of furnace management software 406 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
removing a first portion of a material from a vessel;
measuring a first parameter of a second portion of the material in the vessel, wherein the second portion of the material remains in the vessel after the removal of the first portion;
determining a volume of the second portion of the material based on the first parameter;
updating a second parameter based on the volume; and
performing a process based on the updated second parameter.

2. The method of claim 1, wherein the volume of the second portion of the material is determined based on an assumption that the volume is shaped as a partial sphere.

3. The method of claim 1, further comprising determining a mass of the second portion of the material based on the volume, wherein the second parameter is updated based on the mass of the second portion of the material.

4. The method of claim 1, wherein the second parameter comprises at least one of an amount of additional material to provide to the vessel, an amount of energy to provide in the vessel, a temperature to bring the material to in the vessel, an amount of additives to provide to the vessel, and an amount of time to perform a heating process in the vessel.

5. The method of claim 4, wherein performing the process comprises at least one of providing the additional material to the vessel, providing the energy to the vessel, bringing the material in the vessel to the temperature, providing the additives to the vessel, and performing a heating process.

6. The method of claim 1, wherein the second portion of the material comprises a steel hot heel and the vessel comprises a steel making vessel.

7. The method of claim 1, wherein the first parameter comprises at least one of a height of the second portion of the material, a size of the second portion of the material, and a shape of the second portion of the material.

8. The method of claim 1, wherein the vessel comprises a part of an Electric Arc Furnace.

9. The method of claim 1, wherein the process comprises a metal making process, and wherein performing the process comprises providing additional material to the vessel, and wherein the amount of the additional material is determined based on the second parameter.

10. The method of claim 9, wherein the metal making process comprises a steel making process.

11. The method of claim 2, further comprising determining a mass of the second portion of the material based on the volume, wherein the second parameter is updated based on the mass of the second portion of the material.

12. The method of claim 2, wherein the second parameter comprises at least one of an amount of additional material to provide to the vessel, an amount of energy to provide in the vessel, a temperature to bring the material to in the vessel, an amount of additives to provide to the vessel, and an amount of time to perform a heating process in the vessel.

13. The method of claim 12, wherein performing the process comprises at least one of providing the additional material to the vessel, providing the energy to the vessel, bringing the material in the vessel to the temperature, providing the additives to the vessel, and performing a heating process.

14. The method of claim 2, wherein the second portion of the material comprises a steel hot heel and the vessel comprises a steel making vessel.

15. The method of claim 2, wherein the second portion of the material comprises a steel hot heel and the vessel comprises a steel making vessel.

16. The method of claim 2, wherein the first parameter comprises at least one of a height of the second portion of the material, a size of the second portion of the material, and a shape of the second portion of the material.

17. The method of claim 2, wherein the vessel comprises a part of an Electric Arc Furnace.

18. The method of claim 2, wherein the process comprises a metal making process, and wherein performing the process comprises providing additional material to the vessel, and wherein the amount of the additional material is determined based on the second parameter.

19. The method of claim 3, wherein the second portion of the material comprises a steel hot heel and the vessel comprises a steel making vessel.

20. The method of claim 3, wherein the second portion of the material comprises a steel hot heel and the vessel comprises a steel making vessel.
